(19) United States
(12) Patent Application Publication
(10) Pub. No.: US 2006/0114998 A1
(43) Pub. Date: Jun. 1, 2006

(54) Video coding method and device

(76) Inventor: Eric BARRAU, Puteaux (FR)

Correspondence Address: PHILIPS INTELLECTUAL PROPERTY & STANDARDS, P.O. BOX 3001, BRIARCLIFF MANOR, NY, 10510, US

(21) Appl. No.: 10/537,616

(22) PCT Filed: Nov. 27, 2003
(86) PCT No.: PCT/IB03/05465

§ 371 Date: Jun. 3, 2005

(30) Foreign Application Priority Data
Dec. 4, 2002 (EP) 02292994.7

(51) Int. Cl. H04B 1/66; H04N 7/12; H04N 11/02; H04N 11/04

(52) U.S. Cl. 375/240.19; 375/240.12; 375/240.23; 375/240.16

(57) ABSTRACT

The invention generally relates to a three-dimensional (3D) video coding method for the compression of a bitstream corresponding to an original video sequence that has been divided into successive groups of N=2ⁿ frames (GOFs), and, more precisely, to a method comprising the following steps: (a) a spatio-temporal analysis step, leading to a spatio-temporal multiresolution decomposition of the current GOF into low and high frequency temporal subbands and itself comprising a motion estimation sub-step, a motion compensated temporal filtering sub-step, performed on each of the 2ⁿ⁻¹ couples of frames of the current GOF, and a spatial analysis sub-step, performed on the subbands resulting from said temporal filtering sub-step; (b) an encoding step, comprising entropy and arithmetic coding sub-steps. According to the invention, when said temporal filtering sub-step comprises (n−1) levels and the final temporal decomposition level that would have led to a single low-frequency subband is omitted, the spatio-temporal analysis and encoding steps are performed according to the following rules: (a) each current input GOF is splitted into two new GOFs with half the original size; (b) in each of these two new GOFs, a complete spatio-temporal multiresolution decomposition with (n−1) levels is performed down to the last low frequency temporal subband; (c) a modified 3D-SPIHT scanning is applied consecutively and independently on these two new GOFs.

The present invention relates to the field of video compression and, more particularly, to a three-dimensional (3D) video coding method for the compression of a bitstream corresponding to an original video sequence that has been divided into successive groups of frames (GOFs) the size of which is N=2ⁿ with n being an integer, these GOFs being themselves subdivided into successive couples of frames (COFs), said coding method comprising the following steps, applied to each successive GOF of the sequence:

a) a spatio-temporal analysis step, performed with a given number of levels at most equal to n and leading to a spatio-temporal multiresolution decomposition of the current GOF into low and high frequency temporal subbands, said step itself comprising:

a motion estimation sub-step;

based on said motion estimation, a motion compensated temporal filtering sub-step, performed on each of the 2ⁿ⁻¹ COFs of the current GOF;

a spatial analysis sub-step, performed on the subbands resulting from said temporal filtering sub-step;

b) an encoding step, said step itself comprising:

an entropy coding sub-step, performed on said low and high frequency temporal subbands resulting from the spatio-temporal analysis step and on motion vectors obtained by means of said motion estimation step;

an arithmetic coding sub-step, applied to the coded sequence thus obtained and delivering an embedded coded bitstream.

The invention also relates to a corresponding video coding device, allowing to implement said coding method.

The first standard video compression schemes were based on so-called hybrid solutions: an hybrid video encoder uses a predictive scheme where each current frame of the input video sequence is temporally predicted from a given reference frame, and the prediction error thus obtained by difference between said current frame and its prediction is spatially transformed (the transform is for instance a bi-dimensional DCT transform) in order to get advantage of spatial redundancies. A more recent approach, called 3D (or 2D+t) subband analysis, has then consisted in processing a group of frames (GOF) as a three-dimensional structure and spatio-temporally filtering it in order to compact the energy in the low frequencies.

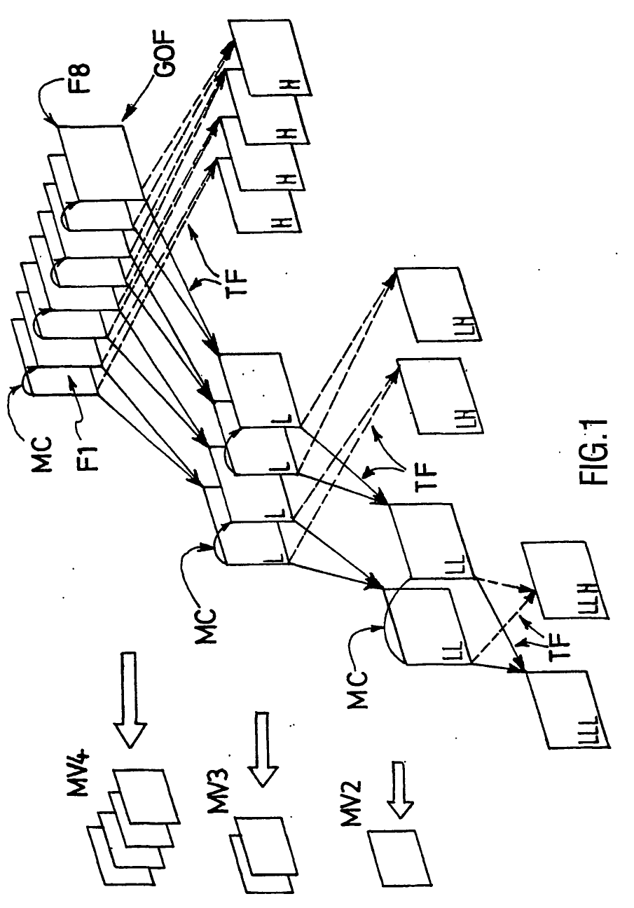

The introduction of a motion compensation step in such a 3D subband decomposition scheme allows to improve the overall coding efficiency and leads to a spatio-temporal multiresolution (hierarchical) representation of the video signal thanks to a subband tree. As depicted for instance in FIG. 1 showing such a 3D wavelet decomposition with motion compensation, each GOF of the input video sequence, including in the illustrated case eight frames F1 to F8, is first motion-compensated (MC) in order to process sequences with large motion, and then temporally filtered (TF) using Haar wavelets (the dotted arrows correspond to a high-pass temporal filtering, while the non dotted arrows correspond to a low-pass temporal filtering). Three stages of decomposition are shown (L and H=first stage; LL and LH=second stage; LLL and LLH=third stage), a group of motion vector fields (respectively MV4, MV3, MV2) being generated at each temporal decomposition level. The high frequency temporal subbands of each level (H, LH and LLH in the above example) and the low frequency temporal subband(s) of the deepest one (LLL) are then spatially analyzed through a wavelet filter, and an entropy encoder allows to encode the wavelet coefficients resulting from this spatio-temporal decomposition. All these operations are similarly applied to the successive GOFs of the input video sequence.

Among the different entropy coding techniques that can be used to encode the 3D wavelet coefficients resulting from this subband decomposition, the so-called 3D-SPIHT algorithm, described for example in the document “Low bit-rate scalable video coding with 3D set partitioning in hierarchical trees (3D-SPIHT)”, K. Z. Xiong and W. A. Pearlman, IEEE Transactions on Circuits and Systems for Video Technology, vol. 10, no 8, December 2000, pp. 1374-1387, is one of the most efficient ones (and also its extension to support scalability, described in “A fully scalable 3D subband video codec,” V. Bottreau, M. Bénetière, B. Pesquet-Popescu and B. Felts, Proceedings of IEEE International Conference on Image Processing, ICIP 2001, vol. 2, pp. 1017-1020, Thessalonild, Greece, Oct. 7-10, 2001).

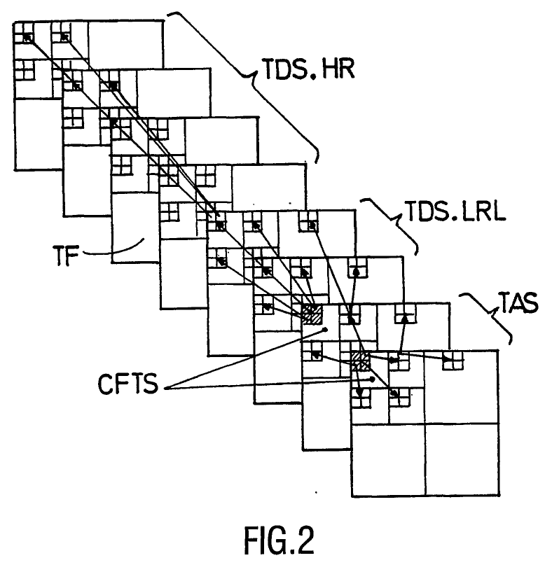

This 3D-SPIHT algorithm is presented in FIG. 2 that illustrates the parent-offspring dependencies observed in the spatio-temporal orientation trees resulting from the subband decomposition (the notations in FIG. 2 are the following: TF=temporal frame, TAS=temporal approximation subbands LL, CFTS=coefficients in the spatio-temporal approximation subbands, or root coefficients, TDS.LRL=temporal detail subbands LH at the last resolution level of the decomposition, and TDS.HR=temporal detail subbands H at higher resolution). Said algorithm is based on a key concept: the prediction of the absence of significant information across successive scales of the wavelet decomposition, by exploiting the self-similarity inherent to natural images (i.e. if a coefficient is insignificant according to a given criterion at the lowest scale of the decomposition, the coefficients corresponding to the same area at the other scales of said decomposition have a high probability to be insignificant as well). The 3D-SPIHT algorithm uses a tree structure—the spatio-temporal orientation tree—that naturally defines the spatial and temporal relationships inside the hierarchical pyramid of the wavelet coefficients (the roots of the trees are composed of the pixels of the approximation subband—or root subband—at the lowest resolution, and the direct descendants—or offspring—of a mode correspond to the pixels of the same volume and direction in the next finer level of the pyramid), and looks for zerotrees in the wavelets subbands in order to reduce redundancies between them. The wavelet coefficients are finally encoded according to their nature: root of a possible zero-tree (or insignificant set), insignificant pixel, and significant pixel.

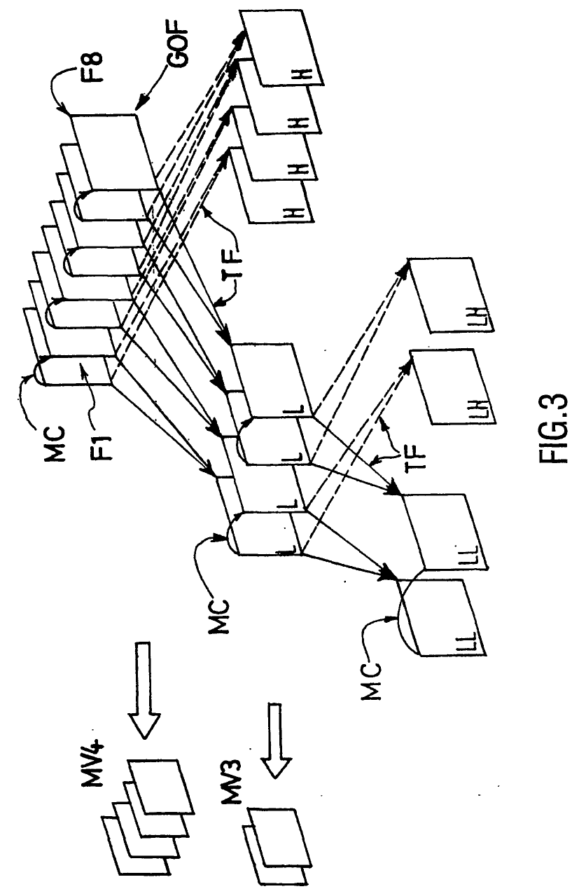

In the literature, when the 3D-SPIHT is used, the temporal decomposition may be stopped (see FIG. 3, to be compared to the case of a complete decomposition as illustrated in FIG. 1) before the final (potential) decomposition step that would lead to a single low-frequency temporal subband. The first temporal dependencies between wavelet coefficients are then applied between the two approximation subbands LL. The meaning of these coefficients is coherent, since they are approximation wavelet coefficients at the same decomposition level, but said coefficients are highly decorrelated because they contain information from very different parts of the sequence: LL0 is indeed computed from the four first input frames of the GOF and LL1 from the four last frames of the same GOF.

It is an object of the invention to propose more efficient coding method with which the dependencies at this deep temporal decomposition level, which do not play a major role in the efficiency of the SPIHT approach (the benefit of exploiting inter-subband correlation appears especially in the first steps of the decomposition), are removed.

To this end, the invention relates to a coding method such as defined in the introductory part of the description and which is moreover characterized in that, when said temporal filtering sub-step comprises (n−1) decomposition levels so that the final temporal decomposition level that would have led to a single low-frequency subband is omitted, the spatio-temporal analysis and encoding steps are performed according to the following rules:

(a) each current input GOF is splitted into two new GOFs with half the original size and half the number of COFs, said new GOFs being independent and comprising respectively the 2ⁿ⁻¹ first frames and the 2ⁿ⁻¹ last ones of said original input GOF;

(b) in each of these two new GOFs, a complete spatio-temporal multiresolution decomposition with (n−1) levels is performed down to the last low frequency temporal subband in order to get only one final approximation subband for each of said new GOFs;

(c) a modified 3D-SPIHT scanning is applied consecutively and independently on these two new GOFs, the spatio-temporal orientation trees used by said SPIHT scanning for defining the spatio-temporal relationships inside the hierarchical pyramid of the wavelet coefficients including now half the original number of subbands with respect to a spatio-temporal decomposition as conventionally performed on the original GOF.

The invention also relates to a video coding device allowing to carry out said method.

To this end, the invention relates to a device comprising:

a) spatio-temporal analysis means applied to each successive GOF of the sequence with a given number of levels at most equal to n and leading to a spatio-temporal multiresolution decomposition of the current GOF into low and high frequency temporal subbands, said analysis means performing:

a motion estimation sub-step;

based on said motion estimation, a motion compensated temporal filtering sub-step, performed on each of the 2ⁿ⁻¹ COFs of the current GOF;

a spatial analysis sub-step, performed on the subbands resulting from said temporal filtering sub-step;

b) encoding means, themselves comprising:

entropy coding means, applied to said low and high frequency temporal subbands resulting from the spatio-temporal analysis step and to motion vectors obtained by means of said motion estimation sub-step;

arithmetic coding means, applied to the coded sequence thus obtained and delivering an embedded coded bitstream;

said video coding device being further characterized in that, when said temporal filtering sub-step comprises (n−1) decomposition levels and the final temporal decomposition level that would have led to a single low-frequency subband is omitted, the spatio-temporal analysis and encoding means use the following rules:

(a) each current input GOF is splitted into two new GOFs with half the original size and half the number of COFs, said new GOFs being independent and comprising respectively the 2ⁿ⁻¹ first frames and the 2ⁿ⁻¹ last ones of said original input GOF;

(b) in each of these two new GOFs, a complete spatio-temporal multiresolution decomposition with (n−1) levels is performed down to the last low frequency temporal subband in order to get only one final approximation subband for each of said new GOFs;

(c) a modified 3D-SPIHT scanning is applied consecutively and independently on these two new GOFs, the spatio-temporal orientation trees used by said SPIHT scanning for defining the spatio-temporal relationships inside the hierarchical pyramid of the wavelet coefficients including now half the original number of subbands with respect to a spatio-temporal decomposition as conventionally performed on the original GOF.

The present invention will now be described, by way of example, with reference to the accompanying drawings in which:

FIG. 1 shows a 3D wavelet decomposition with motion compensation, applied to a GOF of the input video sequence;

FIG. 2 shows the parent-offspring dependencies observed in the spatio-temporal orientation trees resulting from said subband decomposition;

FIG. 3 illustrates the case of an uncompleted temporal multiresolution analysis with motion compensation as performed in previous solutions applying the 3D-SPIHT algorithm, said decomposition being stopped before the final decomposition step that leads to a single low-frequency temporal subband;

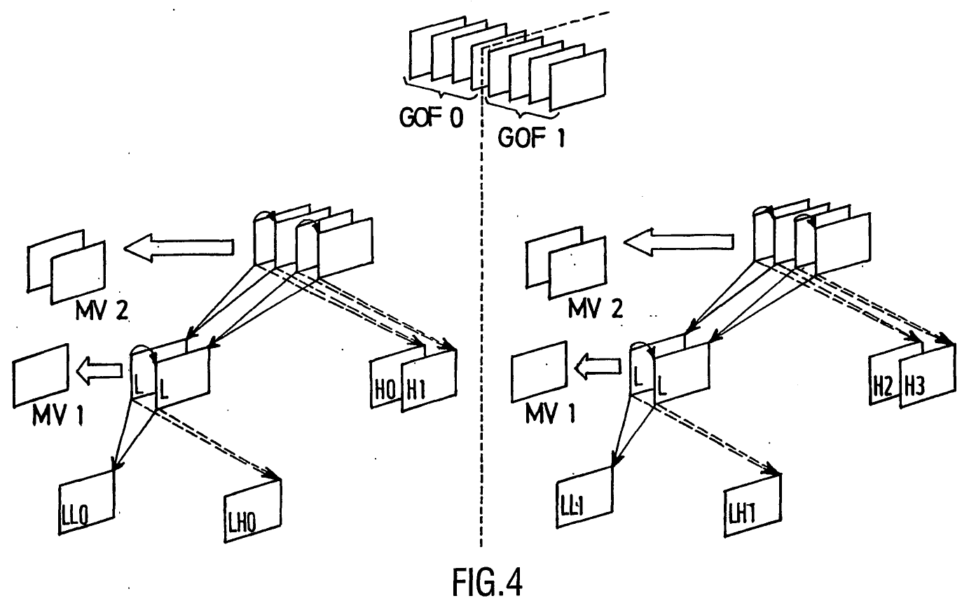

FIG. 4 illustrates a temporal decomposition performed in accordance with the principle of the invention;

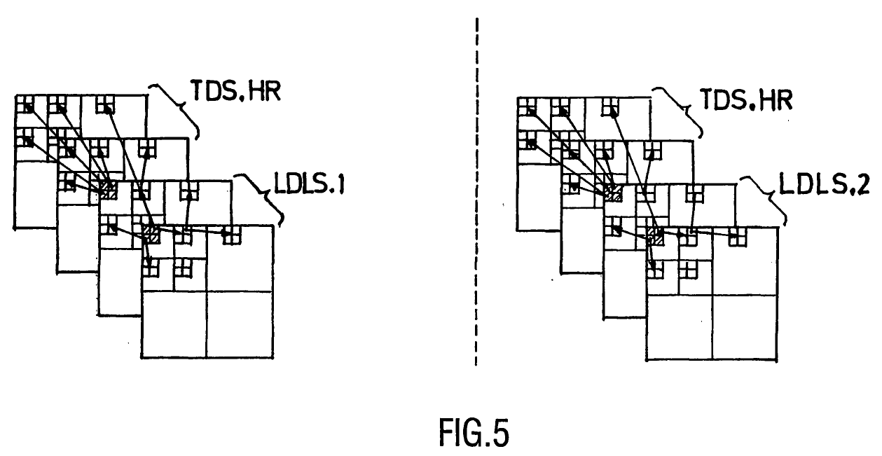

FIG. 5 shows the new parent-offspring dependencies observed in the spatio-temporal orientation trees when performing the temporal decomposition in accordance with said principle of the invention.

In order to remove dependencies between the two approximation subbands LL0 and LL1 of the uncompleted temporal decomposition of FIG. 3, it is first proposed to split the current input GOF into two separate new GOFs with half the original size. A temporal decomposition is then performed for each separate GOF, said temporal decomposition being complete (i.e. performed down to the last low temporal subband) in order to get only one final approximation subband for each new GOF.

This new temporal decomposition is illustrated in FIG. 4, in which the vertical dashed line shows the new separation for the GOF structure. Each new GOF (with half the original size, with respect to the original ones) can be considered as independent and all the information corresponding respectively to each one of these two GOFs, called “GOF 0” and “GOF 1”, is transmitted independently. All the information of “GOF 0” is transmitted first (motion vectors and subbands), the natural order for the subband transmission being LL0, LH0, H0 and finally H1, and all the information of “GOF 1” is then transmitted, the natural order for the subband transmission being similarly LL1, LH1, H2 and finally H3.

Starting from this new temporal decomposition, the original SPIHT scanning of FIG. 2 is modified, in order to discard dependencies between subbands from different GOFs. This new scanning is applied consecutively on the two new GOFs (of four frames in the given example), and a different set of parent-offspring dependencies, shown in FIG. 5 (in which TDS.HR has the same meaning as in FIG. 2, LDLS.1 designates the last decomposition level subbands for the first part of the GOF, i.e. LL0 and LH0, and LDLS.2 designates the last decomposition level subbands for the second part of the GOF, i.e. LL1 and LH1), is used to remove the dependencies between the two approximation subbands LL0 and LL1, and therefore the dependencies between the two new GOFs.

The technical solution thus proposed halves the number of frames per GOF for a given number of decomposition levels. This can be considered as a major improvement when compared to the original solution, because it halves the memory requirement both at the encoding side and at the decoding side. Moreover, this approach does not bring any penalty to the coding efficiency, since the modified dependencies only affect the temporal approximation subbands that can be considered as uncorrelated.

It may be noted that the new SPIHT scanning illustrated in FIG. 5 could be associated successfully with the original GOF size of FIG. 3: in that case, the subband transmission can be interleaved in order to send most important information first (the transmission order would then be the original transmission order: LL0, LL1, LH0, LH1, H0, H1, H2, H3). Nevertheless, even though the dependencies between the approximation subbands have been removed, the GOF size is the original GOF size and the benefit in terms of memory requirements is lost.

1. A three-dimensional (3D) video coding method for the compression of a bitstream corresponding to an original video sequence that has been divided into successive groups of frames (GOFs) the size of which is N=2ⁿ with n being an integer, these GOFs being themselves subdivided into successive couples of frames (COFs), said coding method comprising the following steps, applied to each successive GOF of the sequence:
a) a spatio-temporal analysis step, performed with a given number of levels at most equal to n and leading to a spatio-temporal multiresolution decomposition of the current GOF into low and high frequency temporal subbands, said step itself comprising:
a motion estimation sub-step;
based on said motion estimation, a motion compensated temporal filtering sub-step, performed on each of the 2ⁿ⁻¹ COFs of the current GOF;
a spatial analysis sub-step, performed on the subbands resulting from said temporal filtering sub-step;
b) an encoding step, said step itself comprising:
an entropy coding sub-step, performed on said low and high frequency temporal subbands resulting from the spatio-temporal analysis step and on motion vectors obtained by means of said motion estimation step;
an arithmetic coding sub-step, applied to the coded sequence thus obtained and delivering an embedded coded bitstream;
said coding method being further characterized in that, when said temporal filtering sub-step comprises (n−1) decomposition levels so that the final temporal decomposition level that would have led to a single low-frequency subband is omitted, the spatio-temporal analysis and encoding steps are performed according to the following rules:
(a) each current input GOF is splitted into two new GOFs with half the original size and half the number of COFs, said new GOFs being independent and comprising respectively the 2ⁿ⁻¹ first frames and the 2ⁿ⁻¹ last ones of said original input GOF;
(b) in each of these two new GOFs, a complete spatio-temporal multiresolution decomposition with (n−1) levels is performed down to the last low frequency temporal subband in order to get only one final approximation subband for each of said new GOFs;
(c) a modified 3D-SPIHT scanning is applied consecutively and independently on these two new GOFs, the spatio-temporal orientation trees used by said SPIHT scanning for defining the spatio-temporal relationships inside the hierarchical pyramid of the wavelet coefficients including now half the original number of subbands with respect to a spatio-temporal decomposition as conventionally performed on the original GOF.

2. A video coding device for the implementation of the three-dimensional video coding method according to claim 1, said device comprising:
(a) spatio-temporal analysis means applied to each successive GOF of the sequence with a given number of levels at most equal to n and leading to a spatio-temporal multiresolution decomposition of the current GOF into low and high frequency temporal subbands, said analysis means performing:
a motion estimation sub-step;
based on said motion estimation, a motion compensated temporal filtering sub-step, performed on each of the 2ⁿ⁻¹ COFs of the current GOF;
a spatial analysis sub-step, performed on the subbands resulting from said temporal filtering sub-step;
b) encoding means, themselves comprising:
entropy coding means, applied to said low and high frequency temporal subbands resulting from the spatio-temporal analysis step and to motion vectors obtained by means of said motion estimation sub-step;
arithmetic coding means, applied to the coded sequence thus obtained and delivering an embedded coded bitstream;
said video coding device being further characterized in that, when said temporal filtering sub-step comprises (n−1) decomposition levels so that the final temporal decomposition level that would have led to a single low-frequency subband is omitted, the spatio-temporal analysis and encoding means use the following rules:
(a) each current input GOF is splitted into two new GOFs with half the original size and half the number of COFs, said new GOFs being independent and comprising respectively the 2ⁿ⁻¹ first frames and the 2ⁿ-last ones of said original input GOF;
(b) in each of these two new GOFs, a complete spatio-temporal multiresolution decomposition with (n−1) levels is performed down to the last low frequency temporal subband in order to get only one final approximation subband for each of said new GOFs;
(c) a modified 3D-SPIHT scanning is applied consecutively and independently on these two new GOFs, the spatio-temporal orientation trees used by said SPIHT scanning for defining the spatio-temporal relationships inside the hierarchical pyramid of the wavelet coefficients including now half the original number of subbands with respect to a spatio-temporal decomposition as conventionally performed on the original GOF.
